(19) United States
(12) Patent Application Publication
(10) Pub. No.: US 2004/0125425 A1
(43) Pub. Date: Jul. 1, 2004

(54) Method for creating stereograms

(76) Inventor: Barney P. Johnson, Owensboro, KY (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/729,481

(22) Filed: Dec. 5, 2003

Related U.S. Application Data
(60) Provisional application No. 60/436,613, filed on Dec. 26, 2002.

(51) Int. Cl. G03H 1/26

(52) U.S. Cl. 359/23

(57) ABSTRACT

A stereogram that consists of a plurality of rows of horizontally repeated text, words, symbols, or designs displayed on an object having a non-planar surface. The repeated text, words, symbols, or designs generally differ from row to row and are horizontally and differentially spaced apart. The elements of the image displayed are perceived to float in space in 3-dimensions as if parts of the image were located on different planes at different distances from the viewer when the point of convergence of the viewer's line of sight lies either in front of or beyond the actual plane of the displayed image. Application of the present invention, the object may be continuously rotated in one direction producing a continuous animated loop. Further, the curvature of the object provides an infinite number of fixed viewing angles. As a result, the viewer is able to experience the stereogram in a way not possible when displayed on a flat surface. Different viewing angles are achieved by focusing on different regions or by rotating the object. Further, since distances between the elements of the image appear to be changing, the effect is that some elements may appear to float and then sink as the object is rotated. In effect, elements appear to rise over the horizon and float past other elements.

### CROSS REFERENCES TO RELATED APPLICATIONS

U.S. Provisional Application for patent 60/436,613, filed Dec. 26, 2002, with title, “Method for Creating Stereograms” which is hereby incorporated by reference. Applicant claims priority pursuant to 35 U.S.C. Par. 119(e)(i).

### STATEMENT AS TO RIGHTS TO INVENTIONS MADE UNDER FEDERALLY SPONSORED RESEARCH AND DEVELOPMENT

Not applicable.

### BACKGROUND OF THE INVENTION

1. Field of the Invention

The present invention relates generally to the field of stereoscopic imagery. More particularly, it concerns a method for creating variable size and variable resolution stereograms on a non-planar surface.

2. Brief Description of Prior Art

A stereogram is a type of image generally created from a set of two-dimensional views of an image. A stereogram is capable of creating the convincing illusion of a solid 3-dimensional image from closely spaced discrete-perspective, 2-dimensional component views. In addition, if the 2-dimensional component views are properly generated, a stereogram can also create the illusion of an animated image. The viewing of stereograms often requires that one learn a particular mode of focusing the eyes. Like most activities, viewing these images requires some practice at first; once viewing has been achieved however, it is relatively easy for an individual to view a large variety of these stereogram images.

Stereoscopic vision is the image perceived by the brain of the two subtly different views received by our two eyes. This effect can be used advantageously in causing flat images to have the appearance of 3-dimensional. These stereograms are a fascinating and entertaining diversion for viewers. As a result, the stereogram promotes a degree of attention and concentration of the viewer's interest to the image, and therefore is likely to maintain the viewer's attention for an extended period of time. As such the use of stereograms in advertising and marketing can be most effective.

There are several methods of presenting these stereogram images to the viewer, among them: special viewing devices, color or polarizing filters, alternate-shutter glasses, and lenticular film. The relevant method of the present invention is referred to as “free-fusion” and is different from other methods because no additional equipment is needed. As such, the viewer simply uses his or her own eyes.

The methods for creating free-fusion stereograms are well known. Two or more similar images are placed horizontally so that the viewer can look at one image with his or her left eye, and another with the right eye. This is accomplished by crossing the eyes, in which case the right eye sees the left image and the left eye sees the right image. Another way is to view the images with the parallel method, whereby the right eye sees the right image and the left eye sees the left image.

When using the cross-eyed viewing method, images (or elements) or parts of the images (sub-elements) which are horizontally farther apart than other elements or sub-elements will seem to be closer to the viewer. With the parallel-eye method, the effect is exactly the opposite. As such, the horizontal distances between the image elements are very important, since they determine the magnitude of depth. They also influence how well the brain can accommodate the merging of two images into one virtual image. If the horizontal distances are not managed well, the image will be distorted, sometimes to the point to where the illusion of depth or reality has been destroyed.

Consideration of the prior art reveals that these stereogram images have been applied exclusively to flat surfaces. The reason for this is that stereograms depend generally on the variation of distance between the elements displayed in the stereogram in the horizontal direction. Any curvature in the horizontal axis would produce a degree of distortion of the stereogram; and, it does not take much distortion to distract from the effect of the stereogram. The applicant is presently unaware of any disclosures that combine stereograms with non-planar surfaces.

As previously described, a stereogram is capable of creating the convincing illusion of a solid 3-dimensional image from spaced 2-dimensional component views, and can further create the illusion of an animated image. However, applying these stereogram images on flat surfaces causes certain limitations to their range of uses, their visual effectiveness, and projecting of such special effects.

As will be seen from the subsequent description, the preferred embodiments of the present invention overcome shortcomings of the prior art.

### SUMMARY OF THE INVENTION

The present invention relates to a method for creating variable size and variable resolution stereograms on an object having a non-planar surface. The stereogram of the present invention consists of a plurality of rows of horizontally repeated text, words, symbols, or designs displayed on an object having a non-planar surface. Said repeated text, words, symbols, or designs generally differ from row to row and are horizontally and differentially spaced-apart. As a result, upon the viewer's proper focusing of the eyes, the elements of the image displayed are perceived to float in space in 3-dimensions as if parts of the image were located on different planes at different distances from the viewer when the point of convergence of the viewer's line of sight lies either in front of or beyond the actual plane of the displayed image. When the stereogram is disposed on a non-planar surface of the present invention, some effects are more readily apparent and easier to control than when the stereogram is displayed on a flat surface as disclosed in the prior art. Application of the present invention, the object may be continuously rotated in one direction producing a continuous animated loop. Further, the non-planar configuration of the object provides an infinite number of fixed viewing angles. As a result, the viewer is able to experience the stereogram in a way not possible when displayed on a flat surface. Different viewing angles are achieved by focusing on different regions of the object or by rotating the object. Further, since distances between the elements of the image appear to be changing, the effect is that some elements may appear to float and then sink as the object is rotated. In effect, elements appear to rise over the horizon and float past other elements.

### BRIEF DESCRIPTION OF THE DRAWINGS

The present invention will be illustrated on the basis of the following description of a preferred embodiment thereof.

FIG. 1 is a simplified illustration of a cylindrical surface having a vertical orientation, with the axis of rotation perpendicular to the viewer's eyes.

FIG. 2 is a simplified illustration of a cylindrical surface having a horizontal orientation, with the axis of rotation parallel to the viewer's eyes.

FIG. 3 is a simplified illustration of a cylindrical surface having an angled orientation, with the axis of rotation neither parallel or perpendicular to the viewer's eyes.

FIG. 4 illustrates a template for a truncated cone shaped surface displaying a row of circular images and a row of star images.

FIG. 5 is a front-view illustration of how the same stereogram is seen on a flat surface and a cylindrical surface using the cross-eyed viewing technique.

### DESCRIPTION OF THE PREFERRED EMBODIMENT

In accordance with the present invention, a method for creating a stereogram is disclosed. More particularly, it concerns a method for creating variable size and variable resolution stereogram on a non-planar surface.

The stereogram of the present invention presents a plurality of displaced images to the viewer as arrays of text, words, symbols, or designs that combine to form a 3-dimensional image effect. As such, this effect is used advantageously in causing the flat 2-dimensional image to have the appearance of 3-dimensional. The result of presenting images in this manner creates both a fascinating and entertaining diversion for viewers. As a result, the stereogram of the present invention promotes a degree of attention and concentration of the viewer's interest to the image, and therefore is likely to maintain the viewer's attention for an extended period of time. As such the use of the present stereogram in advertising can be most effective.

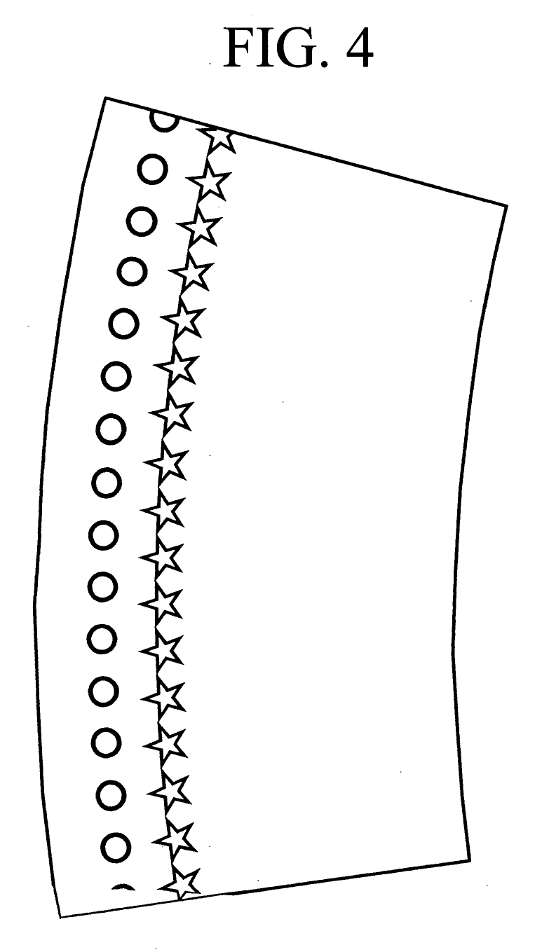

The stereogram of the present invention consists of a plurality of rows of horizontally repeated text, words, symbols, or designs displayed on an object as will be further described. As illustrated in FIG. 4, the repeated text, words, symbols, or designs generally differ from row to row and are horizontally and differentially spaced-apart. As a result, upon the viewers' proper focusing of the eyes, the elements of the image displayed are perceived to float in space in 3-dimensions as if parts of the image were located on different planes at different distances from the viewer when the point of convergence of the viewer's line of sight lies either in front of or beyond the actual plane of the displayed image.

In accordance with the principles of the present invention, said plurality of rows of horizontally repeated text, words, symbols, or designs as described above, are disposed on and about an object having a non-planar surface. In the preferred embodiment, said object having the non-planar surface may be a can, bottle, or cup associated with containing a variety of beverages or foodstuffs, commonly known to the consuming public and seen in grocery stores and the like. However, any object having a non-planar surface will result in the desired objective.

As previously described, a stereogram is capable of creating the convincing illusion of a solid 3-dimensional image from spaced 2-dimensional component views, and can further create the illusion of an animated image. Application of the present invention namely, displaying said plurality of rows of repeated text, words, symbols, or designs, on a non-planar surface serves to accentuate the image's visual effectiveness and special effects.

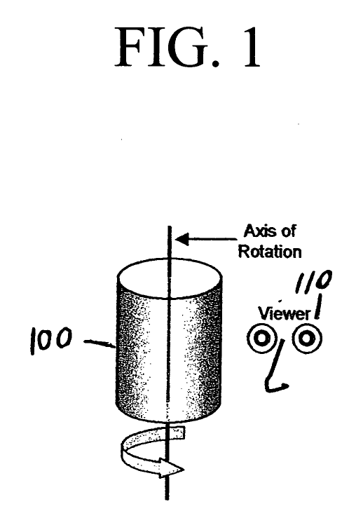

Referring to FIG. 1, which illustrates a cylindrical surface 100 with the axis of rotation parallel to the viewer's eyes 110 and perpendicular to the viewer's eyes 110. In this application, two or more elements (not shown) are aligned parallel to the axis of rotation. The distances between the elements or sub-elements within the elements are varied to produce a stereogram that when viewed by a free-fusion viewing method, produces an illusion of depth. In this case, since there is no curvatures in the horizontal dimension, there is no horizontal distortion of this stereographic image. The image is distorted in the vertical direction by the curvature of the surface, but this produces a new and desired effect. Because the viewing angle of the image is changed when the cylinder is rotated, the distance of the elements from the surface 100 seems to change, and the position of elements or sub-elements relative to one another change. Elements seem to rise up at the horizon and float past other elements.

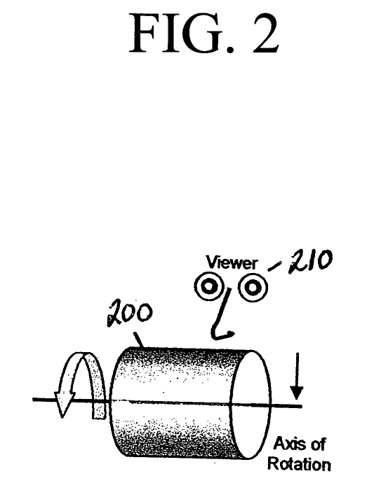

FIG. 2 illustrates a cylindrical surface 200 with the axis of rotation perpendicular to the viewer's eyes 210 and parallel to the viewer's eyes 210. Two or more elements (not shown) are aligned perpendicular to the axis of rotation. The distances between the elements or sub-elements within the elements are varied to produce a stereogram that when viewed by a free-fusion viewing method, produces an illusion of depth. The maximum distance between the elements is equivalent to the radius of the cylinder.

Beyond this limit the distortion of the horizontal distance between the elements become so great that a useful stereographic image cannot be produced. The distortion due to surface curvature decreases as elements are moved closer together, but is never entirely eliminated. However, the brain is able to overcome minor distortions so that a useful stereographic image can be produced. The artist can vary the size and complexity of the elements, as well as the distance between them to optimize the stereographic effect and clarity of the resulting image. Again, because the viewing angle, and also the perceived horizontal aspect of the elements and the perceived distance between the elements changes as the cylinder is rotated, the distance of the elements from the cylindrical surface 200 seems to change, and the position of elements or sub-elements relative to one another change. Elements seem to rise up at the horizon and float past other elements.

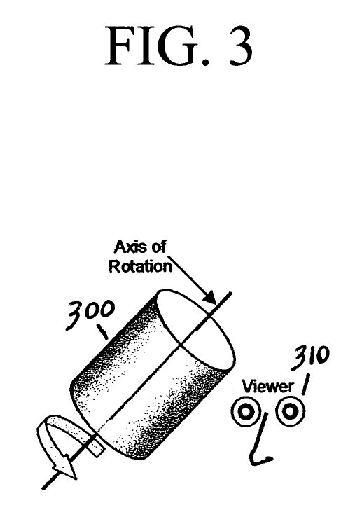

FIG. 3 illustrates a cylindrical surface 300 with the axis of rotation neither parallel or perpendicular to the viewer's eyes 310. The maximum limit becomes a distance equivalent to the radius of the cylinder divided by the sine of the angle of the axis of rotation with respect to a line parallel to the viewer's eyes.

[image]

So, when the cylinder is in a vertical orientation the limit is one radius. When the cylinder is horizontal, there is effectively no limit.

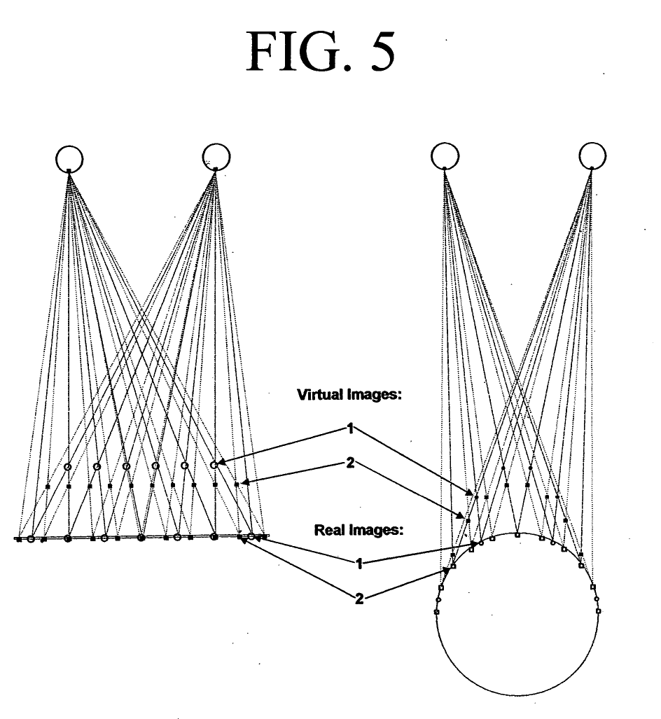

When the stereogram is disposed on a non-planar surface of the present invention, some effects are more readily apparent and easier to control than when the stereogram is displayed on a flat surface as disclosed in the prior art. In addition to the floating effect as discussed above, an illusion of relative movement of elements can be noticed when the viewing angle is adjusted. As shown in FIG. 5, when viewing a flat surface stereogram, the effect is limited since the pattern is constrained by the edges of the sheet, and the angle of viewing is hard to control. Application of the present invention, the object may be continuously rotated in one direction producing a continuous animated loop. Further, the curvature of the object provides an infinite number of fixed viewing angles. As a result, the viewer is able to experience the stereogram in a way not possible when displayed on a flat surface. Different viewing angles are achieved by focusing on different regions or by rotating the object.

Further, while the distances between the elements of the image are fixed, on a non-planar surface they appear to be changing. The effect is that some elements may appear to float and then sink as the object is rotated. In effect, elements appear to rise over the horizon and float past other elements.

As a result of the stereogram disclosed in the present invention having both new effects and accentuated effects when compared to the presentation of prior art stereograms, it should be obvious that the stereogram of the present invention presents advantages not heretofore available. The stereogram disclosed will further promote the degree of attention and concentration of the viewer's interest to the image displayed, and therefore will likely maintain the viewer's attention for an extended period of time.

Further the present stereogram is most suitable for use in the advertising community since, in the preferred embodiment, the stereogram is disposed on an object having a non-planar surface, such as a can, bottle, or cup commonly seen in grocery stores and the like. As such the use of the present invention stereogram in advertising can be most effective.

Although the description above contains many specificities, these should not be construed as limiting the scope of the invention but as merely providing illustrations of some of the presently preferred embodiments of this invention. For example, while in the preferred embodiment the stereogram is disposed on a can or bottle commonly seen in grocery stores and the like, the stereogram of the present invention may be disposed on other shape objects having a non-planar surface. Further, while the stereogram of the present invention is well-suited for advertising as previously discussed, it is as well suited in the field of marketing, promotion, art, education, scientific investigation, medicine, industry and other endeavors.

Thus the scope of the invention should be determined by the appended claims in the formal application and their legal equivalents, rather than by the examples given.

I claim:

1. A method for creating variable size and variable resolution stereograms on a non-planar surface, said method comprising the steps of:
selecting a first elemental image, said first image consisting of text, words, symbols, or designs;
selecting a second elemental image, said second image consisting of text, words, symbols, or designs;
positioning a plurality of rows of the first image on an object having a non-planar surface;
positioning a plurality of rows of the second image on the object having the non-planar surface;
wherein said rows of the repeated first image differ from row to row and are horizontally and differentially spaced apart;
wherein the rows of the repeated second image differ from row to row and are horizontally and differentially spaced apart.

2. A stereogram comprising:
a plurality of rows of repeated elements, said elements differ from row to row and are horizontally and differentially spaced apart,
wherein the rows of repeated elements are displayed on an object having a non-planar surface,
wherein the elements are horizontally and differentially spaced apart,
wherein said rows of repeated elements are disposed on the non-planar object so that an image displayed are perceived to float in space in 3-dimensions as if parts of the image were located on different planes at different distances from a viewer.

3. The stereogram as recited in claim 2, wherein the repeated elements are text.

4. The stereogram as recited in claim 2, wherein the repeated elements are symbols.

5. The stereogram as recited in claim 2, wherein the repeated elements are designs.

6. A stereogram comprising:
a plurality of rows of a first element;
a plurality of rows of a second element;
wherein said rows of the first element are displayed on a non-planar surface;
wherein said rows of the second element are displayed on the non-planar surface;
wherein a separated distance of said first and second elements determine a perceived depth of said first and second elements.
